(19) United States
(12) Patent Application Publication
(10) Pub. No.: US 2026/0253352 A1
(43) Pub. Date: Aug. 27, 2026

(54) RADIO FREQUENCY MODEL ADAPTATION TECHNIQUES

(71) Applicant: QUALCOMM Incorporated, San Diego, CA (US)

(72) Inventors: Satyam GABA, San Diego, CA (US); Lokesh JAIN, San Diego, CA (US); Parag Mohan KANADE, San Diego, CA (US); Sony AKKARAKARAN, Poway, CA (US)

(21) Appl. No.: 19/457,101

(22) Filed: Jan. 22, 2026

Related U.S. Application Data
(60) Provisional application No. 63/763,768, filed on Feb. 26, 2025.

(51) Int. Cl. G06T 19/20; G06T 17/20

(52) U.S. Cl. CPC G06T 19/20; G06T 17/20; G06T 2210/12; G06T 2219/2004; G06T 2219/2016

(57) ABSTRACT

Methods, systems, and devices for radio frequency (RF) model adaptation are described. Various aspects relate to RF models based on digital twins, where one or more regions of a digital twin may be adapted to incorporate higher fidelity data than other portions of the digital twin. A digital twin creation entity may obtain data associated with an original three-dimensional (3D) model of a locality. The digital twin creation entity may adapt the original 3D model based on selection of one or more regions of the 3D model for refinement. Higher fidelity model information may be obtained for the selected regions, and the 3D model updated to incorporate the higher fidelity model information.

### CROSS REFERENCES

The present Application for Patent claims benefit of U.S. Provisional Patent Application No. 63/763,768 by GABA et al., entitled “RADIO FREQUENCY MODEL ADAPTATION TECHNIQUES,” filed Feb. 26, 2025, assigned to the assignee hereof, and expressly incorporated herein.

### FIELD OF TECHNOLOGY

The following relates to radio frequency (RF) model adaptation, including RF model adaptation techniques for digital twins.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for RF model adaptation by an apparatus is described. The method may include obtaining an initial three-dimensional (3D) model of a locality associated with the RF model, the initial 3D model associated with a set of multiple regions that each have associated RF properties, selecting one or more regions of the initial 3D model to be updated with enhanced physical characteristics relative to corresponding physical characteristics in the initial 3D model, the one or more regions selected based on an associated impact to the RF model, obtaining one or more higher fidelity 3D models of each of the one or more regions to be updated, the one or more higher fidelity 3D models providing the enhanced physical characteristics for a corresponding region of the one or more regions to be updated, and updating the initial 3D model with the one or more higher fidelity 3D models to provide an adapted 3D model of the locality associated with the RF model.

An apparatus for RF model adaptation is described. The apparatus may include one or more memories storing processor executable code, and one or more processors coupled with the one or more memories. The one or more processors may individually or collectively be operable to execute the code to cause the apparatus to obtain an initial 3D model of a locality associated with the RF model, the initial 3D model associated with a set of multiple regions that each have associated RF properties, select one or more regions of the initial 3D model to be updated with enhanced physical characteristics relative to corresponding physical characteristics in the initial 3D model, the one or more regions selected based on an associated impact to the RF model, obtain one or more higher fidelity 3D models of each of the one or more regions to be updated, the one or more higher fidelity 3D models providing the enhanced physical characteristics for a corresponding region of the one or more regions to be updated, and update the initial 3D model with the one or more higher fidelity 3D models to provide an adapted 3D model of the locality associated with the RF model.

Another apparatus for RF model adaptation is described. The apparatus may include means for obtaining an initial 3D model of a locality associated with the RF model, the initial 3D model associated with a set of multiple regions that each have associated RF properties, means for selecting one or more regions of the initial 3D model to be updated with enhanced physical characteristics relative to corresponding physical characteristics in the initial 3D model, the one or more regions selected based on an associated impact to the RF model, means for obtaining one or more higher fidelity 3D models of each of the one or more regions to be updated, the one or more higher fidelity 3D models providing the enhanced physical characteristics for a corresponding region of the one or more regions to be updated, and means for updating the initial 3D model with the one or more higher fidelity 3D models to provide an adapted 3D model of the locality associated with the RF model.

A non-transitory computer-readable medium storing code for RF model adaptation is described. The code may include instructions executable by one or more processors to obtain an initial 3D model of a locality associated with the RF model, the initial 3D model associated with a set of multiple regions that each have associated RF properties, select one or more regions of the initial 3D model to be updated with enhanced physical characteristics relative to corresponding physical characteristics in the initial 3D model, the one or more regions selected based on an associated impact to the RF model, obtain one or more higher fidelity 3D models of each of the one or more regions to be updated, the one or more higher fidelity 3D models providing the enhanced physical characteristics for a corresponding region of the one or more regions to be updated, and update the initial 3D model with the one or more higher fidelity 3D models to provide an adapted 3D model of the locality associated with the RF model.

In some examples, to select the one or more regions of the initial 3D model, the method, apparatuses, and non-transitory computer-readable medium described herein, may include further operations, features, means, or instructions for one or more identifying one or more of occluded or obstructed regions of the initial 3D model, one or more regions associated with a higher density of RF devices relative to other regions, one or more coverage boundaries associated with one or more RF network nodes, and one or more RF metrics associated with the one or more regions.

In some examples, to select the one or more regions of the initial 3D model, the method, apparatuses, and non-transitory computer-readable medium described herein, may include further operations, features, means, or instructions for one or more identifying one or more of an associated confidence of RF attributes of the first region that are below a threshold confidence value, one or more anomalies of an RF model output associated with the first region, one or more discrepancies of an expected physical property of the first region, and an unexpected physical property of the first region relative to a corresponding physical property of an adjacent a second region.

In some examples of the method, apparatuses, and non-transitory computer-readable medium described herein, the initial 3D model may be based on a first order survey associated with the locality, and the one or more higher fidelity 3D models may be based on data associated with the selected regions collected by additional sensors or reconstruction techniques. In some examples of the method, apparatuses, and non-transitory computer-readable medium described herein, the one or more higher fidelity 3D models may be based on data collected from one or more LiDAR sensors, radar sensors, stereo cameras, standard cameras, acoustic sensors, or any combinations thereof.

Some examples of the method, apparatuses, and non-transitory computer-readable medium described herein may further include operations, features, means, or instructions for outputting a request to a user equipment (UE) to collect one or more targeted scans of the one or more selected regions.

In some examples of the method, apparatuses, and non-transitory computer-readable medium described herein, updating the initial 3D model may include operations, features, means, or instructions for performing a coarse alignment between a first selected region and a first higher fidelity 3D model associated with the first selected region and performing a fine alignment between portions of the first selected region and corresponding portions of the first higher fidelity 3D model. In some examples of the method, apparatuses, and non-transitory computer-readable medium described herein, the coarse alignment matches one or more anchor points between the first selected region and the first higher fidelity 3D model, and aligns a bounding box associated with the selected region with a corresponding bounding box of the first higher fidelity 3D model. In some examples of the method, apparatuses, and non-transitory computer-readable medium described herein, the fine alignment may be based on an iterative algorithm to reduce residual error between overlapping mesh portions of the first selected region and the first higher fidelity 3D model.

In some examples of the method, apparatuses, and non-transitory computer-readable medium described herein, the data from the initial 3D model may be replaced in the one or more selected regions by associated data of one or more corresponding higher fidelity 3D models. In some examples of the method, apparatuses, and non-transitory computer-readable medium described herein, data from the initial 3D model may be combined with associated data of one or more corresponding higher fidelity 3D models in the one or more selected regions.

In some examples of the method, apparatuses, and non-transitory computer-readable medium described herein, the data of the one or more corresponding higher fidelity 3D models may be weighted when combined with the data from the initial 3D model, and where a magnitude of the weighting may be based on a reliability of an associated source of the one or more higher fidelity 3D models. In some examples of the method, apparatuses, and non-transitory computer-readable medium described herein, the 3D model may be representation of one or more objects in spatial dimensions using 3D units that include one or more of point cloud units, 3D mesh units, or voxel units.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports radio frequency (RF) model adaptation techniques in accordance with one or more aspects of the present disclosure.

FIG. 2 shows an example of a digital twin creation or refinement procedure that supports RF model adaptation techniques in accordance with one or more aspects of the present disclosure.

FIGS. 3A and 3B show examples of an initial model image and updated model image in accordance with one or more aspects of the present disclosure.

FIGS. 4 and 5 show block diagrams of devices that support RF model adaptation techniques in accordance with one or more aspects of the present disclosure.

FIG. 6 shows a block diagram of a digital twin creation entity that supports RF model adaptation techniques in accordance with one or more aspects of the present disclosure.

FIG. 7 shows a diagram of a system including a UE that supports RF model adaptation techniques in accordance with one or more aspects of the present disclosure.

FIG. 8 shows a diagram of a system including a network entity that supports RF model adaptation techniques in accordance with one or more aspects of the present disclosure.

FIGS. 9 and 10 show flowcharts illustrating methods that support RF model adaptation techniques in accordance with one or more aspects of the present disclosure.

### DETAILED DESCRIPTION

Some network operators, controllers, providers, or planners/developers may create and use a digital twin associated with a geographic area or locality to help make decisions, predictions, or estimations associated with a wireless communications system located within the geographic area. As described herein, a geographic area or locality may include an indoor area (e.g., inside a building or structure), an outdoor area, or any combination of one or more indoor areas and one or more outdoor areas. A digital twin associated with a geographic area or locality may enable interested parties to use digital models to (at least approximately) replicate one or more devices, objects, processes, or conditions of the geographic area (or of the wireless communications system) and perform simulations within a virtual representation of the geographic area. In other words, a digital twin associated with a geographic area may be referred to or understood as a virtual environment or a virtual representation of the geographic area and may be used to perform one or more of various simulations. Such simulations performed using the digital twin may provide insight into how devices, objects, processes, or conditions of a real-world version of the geographic area interact or perform, among other examples. For example, a digital twin associated with a geographic area may be used to simulate, predict, or estimate one or more radio frequency (RF) metrics associated with wireless communications within the geographic area. A digital twin creation entity may generate, create, construct, or otherwise output a digital twin. Such a digital twin creation entity may be included within a server or may be or may include one or more servers, one or more processing systems, one or more devices, or any combination thereof, any of which may be collocated or non-collocated. A digital twin creation entity may generate a digital twin based on original input data and may update the digital twin over time.

A digital twin creation entity may use input map data of a geographic area to generate a digital twin. Such input map data may be obtained in accordance with lidar-based techniques, radar-based techniques, red-green-blue (RGB) camera techniques, or depth camera-based techniques. Additionally, or alternatively, such input map data may include data associated with a three-dimensional model of the geographic area (e.g., obtained from a third-party vendor). Across such various options, the input map data may be based on images or measurements of the geographic area that is a somewhat coarse, such as based on a first order survey. Such relatively coarse data may provide sufficient information for model generation (e.g., for a RF model) for most aspects of an area, but some regions within the area may have incomplete or inaccurate data. For example, three-dimensional models of some geographic areas may be generated using images taken from one or more aerial devices (e.g., a satellite, a drone, or a low-flying airplane), and may have occluded areas that are not visible in the generated images but which may have an impact on a RF model that is based on such imagery. Thus, using a digital twin generated based on first order survey data or measurements of a geographic area may result in some regions with an inaccurate representation, which may result in inaccurate simulations (e.g., such that simulation results using the digital twin are dissimilar to actual measurements within a real-world version of the geographic area). Thus, digital twin creation and refinement techniques that provide for adapted RF models for such regions with inaccurate representation may be desirable. Further, techniques that generate higher fidelity data may be relatively expensive and produce substantially more data that uses more processing resources relative to coarser data. For example, lidar-based techniques, radar-based techniques, and depth camera-based techniques may be associated with a relatively large amount of manual labor and, accordingly, may be performed sparingly (e.g., once or relatively infrequently).

Various aspects generally relate to digital twin creation and refinement techniques in which an RF model may be adapted based on selection of one or more regions of a model for refinement, obtaining higher fidelity model information for the selected regions, and updating the RF model to incorporate the higher fidelity model information. In some aspects, one or more regions of interest (ROI) may be identified in an initial RF three-dimensional (3D) model. For example, certain regions of a locality may have higher impact on RF simulation outcomes and thus may be prime candidates for repair, such as occluded or obstructed areas (e.g., areas under overhangs, or adjacent to dense foliage), key RF interaction sites (e.g., sites that have a high user density, or locations for transmitters and/or receivers), key RF failure or potential failure sites (e.g., handover boundaries, cell edges), or areas with anomalous RF energy metrics (e.g., regions exhibiting higher reflection or scattering patterns, strong and/or large number of multipaths, high delay-spread, and the like, in simulation logs). In some aspects, one or more ROIs may be identified by vision tools, may be identified from over-the-air logs or real-time simulations, or both. In some aspects, a knowledge base of common occlusion and different reconstruction areas may be used to identify one or more ROIs.

In some aspects, a digital twin creation entity may detect and localize errors or boundaries of an initial 3D model that are candidates for obtaining higher fidelity model information. Such detection may be based on initial reconstruction confidence (e.g., confidence scores from a reconstruction pipeline, such as photogrammetry or simultaneous localization and mapping (SLAM)), ray tracing anomalies (e.g., unexpected reflections or diffraction behaviors in the RF model can signify surface irregularities or missing geometry), material mismatch (e.g., discrepancies in expected versus observed materials, such as a lawn made of glass, which may be identified based on a knowledge base or some database of prior info that can be used to flag such mismatches), or spatial neighbors (e.g., adjacent patches in a mesh with significantly different reconstruction quality or abrupt changes in surface normal, where cases such as two walls or an edge of a building may be excluded).

In some aspects, based on the identified ROIs, the 3D model may be “patched” with higher fidelity mesh data generated using data collected by additional sensors or reconstruction methods. For example, higher fidelity data may be obtained from sensors such as LiDAR, stereo cameras, or standard cameras. Additionally, or alternatively, higher fidelity data may be obtained from methods such as SLAM, photogrammetry, or machine learning (ML) (e.g., based on methods such as neural radiance fields (NeRF) or Gaussian splatting). In some cases, an agent or UE may be directed by a network entity or digital twin server to collect targeted scans at specific ROIs, which may include scanning particular anchor points which may not directly be or lie in a selected ROI themselves but may help with alignment of the higher fidelity data.

In some aspects, the initial 3D model may be patched with the obtained higher fidelity 3D models. When combining the data, a coarse alignment may be performed to match anchor points between the initial 3D model and the higher fidelity 3D model data (e.g., using tools like scale invariant feature transform (SIFT) and oriented fast and rotated brief (ORB) feature extractor), and align a bounding box or key landmarks to get an approximate overlay. A fine alignment may be performed, such as by using an iterative closest point (ICP) or similar algorithm to minimize residual error between overlapping mesh regions. In some aspects, the original mesh may be replaced with the new data (e.g., if the discrepancy is large or if the confidence of the new scan is high). In other aspects, both meshes may be combined by assigning a confidence weight to each source (e.g., adding a weighting factor based on overall priority or reliability of each source). The adapted 3D model may be used for various functions, such as RF simulations associated with the corresponding locality.

Aspects of the subject matter described in this disclosure can be implemented to realize one or more of the following potential advantages. For example, by outputting an adaptation of a digital twin associated with the geographic area that provides higher fidelity data for selected regions, the digital twin creation entity may keep an accurate digital twin associated with the geographic area using high fidelity survey data for only portions of the digital twin, and using coarse data for other portions of the digital twin. Such techniques may provide higher simulation accuracy with relatively small incremental computational cost, and with a relatively small increase in model size by focusing only on selected areas that are more critical to model output. Such adapted digital twins may provide improved overall simulation performance through targeted mesh repair or regeneration, which may lead to simulation results from the digital twin being more accurate (e.g., more representative or more similar to results obtained from actual measurements or tests within the real-world geographic area). Further, in accordance with the digital twin providing more accurate simulation results, the digital twin may be used to make better decisions, predictions, or estimations associated with wireless communications within the geographic area, which may facilitate greater system capacity, higher data rates, and greater spectral efficiency, among other benefits.

Aspects of the disclosure are initially described in the context of wireless communications systems. Additionally, aspects of the disclosure are illustrated by and described with reference to a digital twin refinement procedure and associated images based on model adaptation. Aspects of the disclosure are further illustrated by and described with reference to apparatus diagrams, system diagrams, and flowcharts that relate to RF model adaptation techniques.

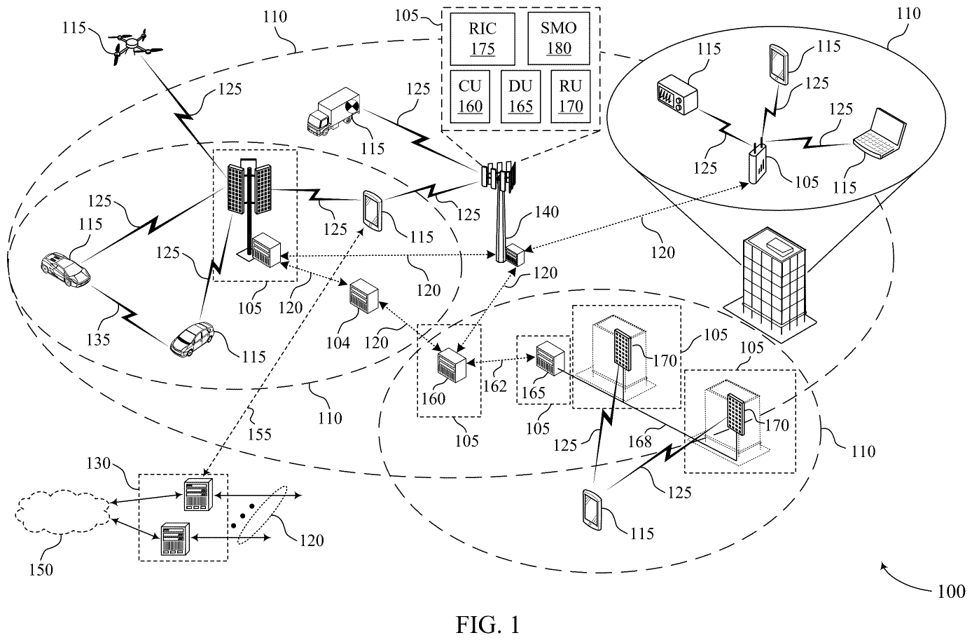

FIG. 1 shows an example of a wireless communications system 100 that supports RF model adaptation techniques in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., an RF access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support RF model adaptation techniques as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be located within a geographic area and, in some cases, a network operator, controller, provider, or planner/developer may create and use a digital twin associated with the geographic area to help make decisions, predictions, or estimations associated with the wireless communications system 100. The network operator, controller, provider, or planner/developer may use the digital twin to model a physical environment in a virtual environment (e.g., a virtual world) and, instead of or in addition to performing measurements or tests within the physical environment, may perform measurements or tests using the model of the physical environment. In other words, a digital twin may be a model of a real-world environment in a virtual world. A digital twin may run any quantity of simulations to study one or multiple processes. A digital twin may have access to near real-time data, such that digital twins may be designed around a two-way flow of information including real-world sensors/measurements (input to a digital twin creation entity) and simulation results (output from the digital twin creation entity).

A digital twin creation entity may generate a digital twin based on a three-dimensional model of a geographic area or locality. Using wireless raytracing, one or more transmitters and one or more receivers may be placed within the three-dimensional model and RF paths between the one or more transmitters and the one or more receivers may be raytraced to generate data, with such data being usable to perform studies to predict, estimate, or otherwise determine one or more metrics associated with wireless communications within the geographic area. A network operator, controller, provider, or planner/developer may use such data and/or metrics to make decisions associated with a real-world version of the wireless communications system 100, as such data and/or metrics may approximate actual data and/or metrics that might have been obtained if measurements or tests within the physical environment were performed. In other words, a digital twin associated with a geographic area including the wireless communications system 100 may leverage or otherwise involve wireless raytracing to simulate or emulate a performance of the wireless communications system 100.

In some implementations, one or more communication devices, nodes, or entities of the wireless communications system 100 may support techniques associated with digital twin creation and adaptation that provides a relatively accurate digital twin in which portions of the digital twin are based on coarser data and other portions are based on higher fidelity data.

As described herein, a digital twin creation entity may create, generate, construct, or otherwise output a digital twin. The digital twin creation entity may be located at or within a network entity 105, a UE 115, or any other node or device associated with the wireless communications system 100. In other words, the digital twin creation entity may be collocated with a network entity 105, a UE 115, or any other node or device associated with the wireless communications system 100. Additionally, or alternatively, the digital twin creation entity may be non-collocated with a network entity 105, a UE 115, or any other node or device associated with the wireless communications system 100. In other words, the digital twin creation entity may be understood as being within a single device or node or distributed across multiple devices or nodes. The digital twin creation entity may be located at or within one or more nodes or devices associated with the core network 130.

In some examples, the digital twin creation entity may obtain data associated with an original 3D model of the geographic area, with the original 3D model being of the geographic area. The digital twin creation entity may adapt the original 3D model based on selection of one or more regions of the 3D model for refinement, obtaining higher fidelity model information for the selected regions, and updating the 3D model to incorporate the higher fidelity model information.

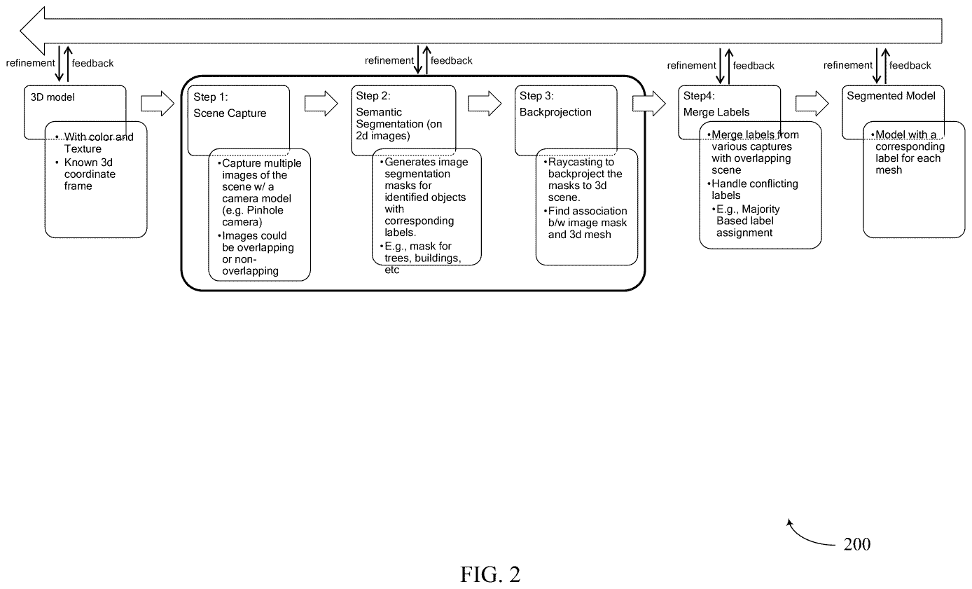

FIG. 2 shows an example of a digital twin creation or refinement procedure 200 that supports RF model adaptation techniques in accordance with one or more aspects of the present disclosure. In accordance with the digital twin creation or refinement procedure 200, a digital twin creation entity may obtain an original three-dimensional model of a geographic area, generate one or more updated three-dimensional models of the geographic area (e.g., based on one or more higher fidelity models of selected ROIs), and generate one or more digital twins associated with the geographic area based on the one or more updated three-dimensional models. The digital twin creation entity may output the one or more digital twins (e.g., to one or more other nodes, entities, servers, memories, or devices).

In some wireless communications systems, one or more characteristics associated with a geographic area may impact wireless communications, such as RF propagation, especially at relatively higher frequencies (e.g., FR2 or FR4 frequencies, among other examples). Such characteristics may include (tree or bush) foliage, structures, or materials of structures, among other examples. In some deployment scenarios, at least some of such characteristics may be occluded from an initial 3D model. Accurate modeling of the physical world may be a high priority performance goal associated with generating a digital twin associated with a geographic area. For example, accurate 3D digital twins of real-world environments may be important for near-over-the-air (OTA) performance evaluations in wireless simulations. Since these simulations often involve ray-tracing with realistic material properties, both the geometry (i.e., shape) and the material assignments (e.g., dielectric constants, reflection coefficients) should be highly accurate. In some cases, material assignment may be made using computer vision, therefore correct texture on the 3D model becomes crucial. However, large-scale 3D models-often derived from aerial or satellite imagery are prone to several issues, such as poor image quality (e.g., due to variations in lighting, occlusions, and sensor noise) that may result in incomplete or erroneous reconstructions, inaccuracies in reconstruction (e.g., holes, gaps or misaligned textures/structures arise when portions of the scene are occluded or poorly captured), material labeling errors (e.g., vision-based or automated labeling can assign incorrect materials if the underlying geometry is wrong), scalability constraints (e.g., achieving high fidelity everywhere is computationally expensive and may not be feasible for large-scale or time-sensitive scenarios. In some cases, attempting to repair every single inaccuracy at full resolution may not be scalable, and various aspects discussed herein provide an efficient techniques that selectively repair or regenerate selected regions of a 3D mesh.

In accordance with the example of FIG. 2, a 3D model may be provided for 3D semantic segmentation (e.g., based on scene capture, semantic segmentation, and back projection). Back projection may refer to a technique according to which a three-dimensional model is “imaged” from one or more known virtual camera positions (within the three-dimensional model or within the digital twin) to obtain unsegmented two-dimensional images. The 3D semantic segmentation may be merged with labels associated with materials, to provide a segmented model with a corresponding label for each mesh (e.g., each mesh triangle of the 3D model). Such a model may be used in RF simulations, as discussed herein. As further discussed herein, a digital twin creation entity may provide the 3D model, and may receive refinement or feedback information that may be used to identify one or more ROIs. In some cases, one or more regions of interest (ROI) may be identified in an initial RF 3D model. For example, certain regions of a locality may have higher impact on RF simulation outcomes and thus may be prime candidates for repair, such as occluded or obstructed areas (e.g., areas under overhangs, or adjacent to dense foliage), key RF interaction sites (e.g., sites that have a high user density, or locations for transmitters and/or receivers), key RF failure or potential failure sites (e.g., handover boundaries, cell edges), or areas with anomalous RF energy metrics (e.g., regions exhibiting higher reflection or scattering patterns, strong and/or large number of multipaths, high delay-spread, and the like, in simulation logs). In some aspects, one or more ROIs may be identified by vision tools, may be identified from over-the-air logs or real-time simulations, or both. In some aspects, a knowledge base of common occlusion and different reconstruction areas may be used to identify one or more ROIs.

In some aspects, the digital twin creation entity may detect and localize errors or boundaries of an initial 3D model that are candidates for obtaining higher fidelity model information. Such detection may be based on initial reconstruction confidence (e.g., confidence scores from a reconstruction pipeline, such as photogrammetry or simultaneous localization and mapping (SLAM)), ray tracing anomalies (e.g., unexpected reflections or diffraction behaviors in the RF model can signify surface irregularities or missing geometry), material mismatch (e.g., discrepancies in expected versus observed materials, such as a lawn made of glass, which may be identified based on a knowledge base or some database of prior info that can be used to flag such mismatches), or spatial neighbors (e.g., adjacent patches in a mesh with significantly different reconstruction quality or abrupt changes in surface normal, where cases such as two walls or an edge of a building may be excluded).

In some aspects, based on the identified ROIs, the 3D model may be “patched” with higher fidelity mesh data generated using data collected by additional sensors or reconstruction methods. For example, higher fidelity data may be obtained from sensors such as LiDAR, stereo cameras, or standard cameras. Additionally, or alternatively, higher fidelity data may be obtained from methods such as SLAM, photogrammetry, or ML (e.g., based on methods such as NeRF or Gaussian splatting). In some cases, an agent or UE may be directed by a network entity or digital twin server to collect targeted scans at specific ROIs, which may include scanning particular anchor points which may not directly be or lie in a selected ROI themselves but may help with alignment of the higher fidelity data.

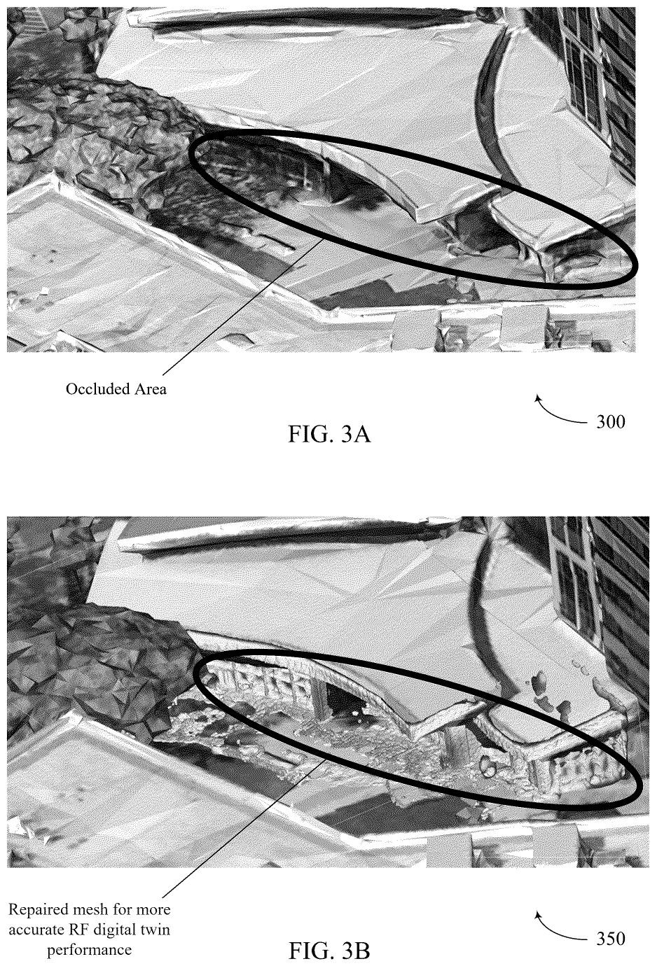

In some aspects, the initial 3D model may be patched with the obtained higher fidelity 3D models. When combining the data, a coarse alignment may be performed to match anchor points between the initial 3D model and the higher fidelity 3D model data (e.g., using tools like SIFT and ORB feature extractors), and align a bounding box or key landmarks to get an approximate overlay. A fine alignment may be performed, such as by using an ICP or similar algorithm to minimize residual error between overlapping mesh regions. In some aspects, the original mesh may be replaced with the new data (e.g., if the discrepancy is large or if the confidence of the new scan is high). In other aspects, both meshes may be combined by assigning a confidence weight to each source (e.g., adding a weighting factor based on overall priority or reliability of each source). The adapted 3D model may be used for various functions, such as RF simulations associated with the corresponding locality. FIGS. 3A and 3B show examples of an initial 3D model and an updated 3D model.

FIGS. 3A and 3B show example of an initial model image 300 and updated model image 350 in accordance with one or more aspects of the present disclosure, such as discussed with reference to FIG. 2. In the example of FIG. 3A, an occluded area may be present, such as an area located beneath a canopy. In accordance with various aspects discussed herein, one or more ROIs may be identified as associated with the occluded area, and higher fidelity data may be provided to a digital twin creation entity, and may be used to provide a more accurate RF digital twin for the occluded area, as shown in the example of FIG. 3B.

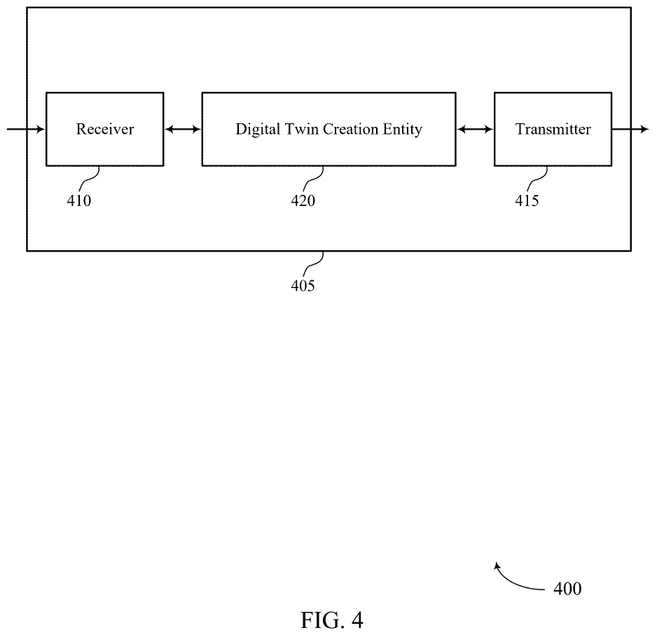

FIG. 4 shows a block diagram 400 of a device 405 that supports RF model adaptation techniques in accordance with one or more aspects of the present disclosure. The device 405 may be an example of aspects of a digital twin server, which may be or be located at a UE 115 or a network entity 105 as described herein. Additionally, or alternatively, the device 405 may include a digital twin server. The device 405 may include a receiver 410, a transmitter 415, and a digital twin creation entity 420. The device 405, or one or more components of the device 405 (e.g., the receiver 410, the transmitter 415, the digital twin creation entity 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to RF model adaptation techniques). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to RF model adaptation techniques). In some examples, the transmitter 415 may be co-located with a receiver 410 in a transceiver module. The transmitter 415 may utilize a single antenna or a set of multiple antennas.

The digital twin creation entity 420, the receiver 410, the transmitter 415, or various combinations or components thereof may be examples of means for performing various aspects of RF model adaptation techniques as described herein. For example, the digital twin creation entity 420, the receiver 410, the transmitter 415, or various combinations or components thereof may be capable of performing one or more of the functions described herein.

In some examples, the digital twin creation entity 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the digital twin creation entity 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the digital twin creation entity 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the digital twin creation entity 420 may be configured to perform various operations (e.g., receiving, obtaining, monitoring, outputting, transmitting) using or otherwise in cooperation with the receiver 410, the transmitter 415, or both. For example, the digital twin creation entity 420 may receive information from the receiver 410, send information to the transmitter 415, or be integrated in combination with the receiver 410, the transmitter 415, or both to obtain information, output information, or perform various other operations as described herein.

The digital twin creation entity 420 may support RF model adaptation in accordance with examples as disclosed herein. For example, the digital twin creation entity 420 is capable of, configured to, or operable to support a means for obtaining an initial 3D model of a locality associated with the RF model, the initial 3D model associated with a set of multiple regions that each have associated RF properties. The digital twin creation entity 420 is capable of, configured to, or operable to support a means for selecting one or more regions of the initial 3D model to be updated with enhanced physical characteristics relative to corresponding physical characteristics in the initial 3D model, the one or more regions selected based on an associated impact to the RF model. The digital twin creation entity 420 is capable of, configured to, or operable to support a means for obtaining one or more higher fidelity 3D models of each of the one or more regions to be updated, the one or more higher fidelity 3D models providing the enhanced physical characteristics for a corresponding region of the one or more regions to be updated. The digital twin creation entity 420 is capable of, configured to, or operable to support a means for updating the initial 3D model with the one or more higher fidelity 3D models to provide an adapted 3D model of the locality associated with the RF model.

By including or configuring the digital twin creation entity 420 in accordance with examples as described herein, the device 405 (e.g., at least one processor controlling or otherwise coupled with the receiver 410, the transmitter 415, the digital twin creation entity 420, or a combination thereof) may support techniques for 3d model adaptation as discussed herein such that the digital twin is an accurate representation of a real-world version of a locality.

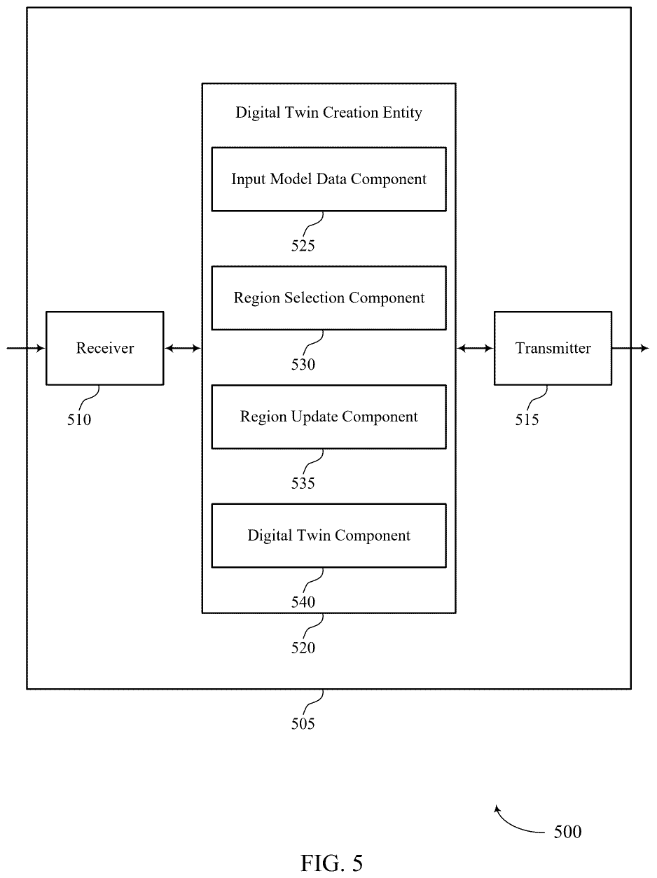

FIG. 5 shows a block diagram 500 of a device 505 that supports RF model adaptation techniques in accordance with one or more aspects of the present disclosure. The device 505 may be an example of aspects of a device 405, a digital twin server, a UE 115, or a network entity 105 as described herein. Additionally, or alternatively, the device 405 may include a digital twin server. The device 505 may include a receiver 510, a transmitter 515, and a digital twin creation entity 520. The device 505, or one or more components of the device 505 (e.g., the receiver 510, the transmitter 515, the digital twin creation entity 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to RF model adaptation techniques). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to RF model adaptation techniques). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of RF model adaptation techniques as described herein. For example, the digital twin creation entity 520 may include an input image data component 525, a region selection component 530, a region update component 535, a digital twin component 540, or any combination thereof. The digital twin creation entity 520 may be an example of aspects of a digital twin creation entity 420 as described herein. In some examples, the digital twin creation entity 520, or various components thereof, may be configured to perform various operations (e.g., receiving, obtaining, monitoring, outputting, transmitting) using or otherwise in cooperation with the receiver 510, the transmitter 515, or both. For example, the digital twin creation entity 520 may receive information from the receiver 510, send information to the transmitter 515, or be integrated in combination with the receiver 510, the transmitter 515, or both to obtain information, output information, or perform various other operations as described herein.

The digital twin creation entity 520 may support RF model adaptation in accordance with examples as disclosed herein. The input image data component 525 is capable of, configured to, or operable to support a means for obtaining an initial 3D model of a locality associated with the RF model, the initial 3D model associated with a set of multiple regions that each have associated RF properties. The region selection component 530 is capable of, configured to, or operable to support a means for selecting one or more regions of the initial 3D model to be updated with enhanced physical characteristics relative to corresponding physical characteristics in the initial 3D model, the one or more regions selected based on an associated impact to the RF model. The region update component 535 is capable of, configured to, or operable to support a means for obtaining one or more higher fidelity 3D models of each of the one or more regions to be updated, the one or more higher fidelity 3D models providing the enhanced physical characteristics for a corresponding region of the one or more regions to be updated. The digital twin component 540 is capable of, configured to, or operable to support a means for updating the initial 3D model with the one or more higher fidelity 3D models to provide an adapted 3D model of the locality associated with the RF model.

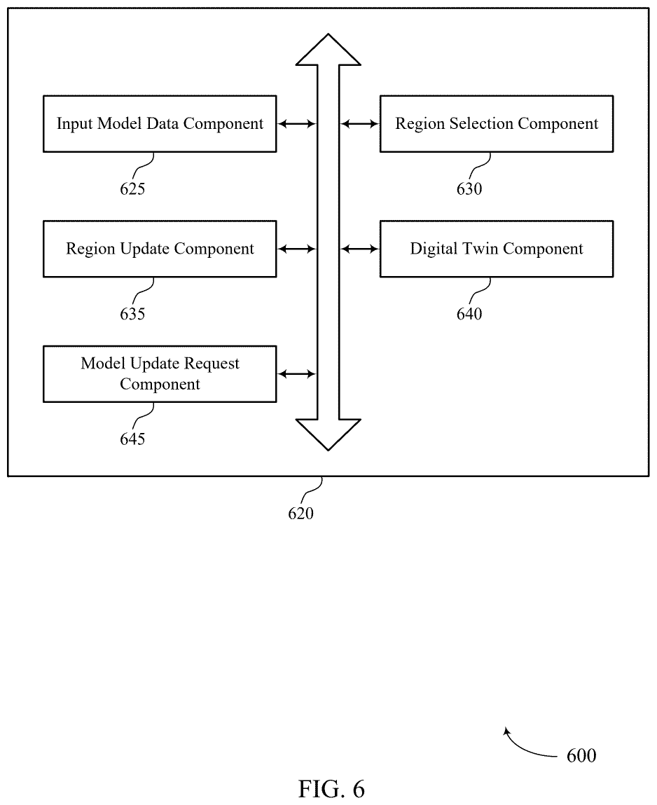

FIG. 6 shows a block diagram 600 of a digital twin creation entity 620 that supports RF model adaptation techniques in accordance with one or more aspects of the present disclosure. The digital twin creation entity 620 may be an example of aspects of a digital twin creation entity 420, a digital twin creation entity 520, or both, as described herein. The digital twin creation entity 620, or various components thereof, may be an example of means for performing various aspects of RF model adaptation techniques as described herein. For example, the digital twin creation entity 620 may include an input image data component 625, a region selection component 630, a region update component 635, a digital twin component 640, a model update request component 645, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The digital twin creation entity 620 may support RF model adaptation in accordance with examples as disclosed herein. The input image data component 625 is capable of, configured to, or operable to support a means for obtaining an initial 3D model of a locality associated with the RF model, the initial 3D model associated with a set of multiple regions that each have associated RF properties. The region selection component 630 is capable of, configured to, or operable to support a means for selecting one or more regions of the initial 3D model to be updated with enhanced physical characteristics relative to corresponding physical characteristics in the initial 3D model, the one or more regions selected based on an associated impact to the RF model. The region update component 635 is capable of, configured to, or operable to support a means for obtaining one or more higher fidelity 3D models of each of the one or more regions to be updated, the one or more higher fidelity 3D models providing the enhanced physical characteristics for a corresponding region of the one or more regions to be updated. The digital twin component 640 is capable of, configured to, or operable to support a means for updating the initial 3D model with the one or more higher fidelity 3D models to provide an adapted 3D model of the locality associated with the RF model.

In some examples, to support selecting one or more regions of the initial 3D model, the region selection component 630 is capable of, configured to, or operable to support a means for identifying one or more occluded or obstructed regions of the initial 3D model. In some examples, to support selecting one or more regions of the initial 3D model the region selection component 630 is capable of, configured to, or operable to support a means for identifying one or more regions associated with a higher density of RF devices relative to other regions. In some examples, to support selecting one or more regions of the initial 3D model, the region selection component 630 is capable of, configured to, or operable to support a means for identifying one or more coverage boundaries associated with one or more RF network nodes. In some examples, to support selecting one or more regions of the initial 3D model, the region selection component 630 is capable of, configured to, or operable to support a means for identifying one or more RF metrics associated with the one or more regions.

In some examples, to support selecting one or more regions of the initial 3D model, the region selection component 630 is capable of, configured to, or operable to support a means for identifying an associated confidence of RF attribute of the first region that is below a threshold confidence value. In some examples, to support selecting one or more regions of the initial 3D model, the region selection component 630 is capable of, configured to, or operable to support a means for identifying one or more anomalies of an RF model output associated with the first region. In some examples, to support selecting one or more regions of the initial 3D model, the region selection component 630 is capable of, configured to, or operable to support a means for identifying one or more discrepancies of an expected physical property of the first region. In some examples, to support selecting one or more regions of the initial 3D model, the region selection component 630 is capable of, configured to, or operable to support a means for identifying an unexpected physical property of the first region relative to a corresponding physical property of an adjacent a second region.

In some examples, the initial 3D model is based on a first order survey associated with the locality, and the one or more higher fidelity 3D models are based on data associated with the selected regions collected by additional sensors or reconstruction techniques. In some examples, the one or more higher fidelity 3D models are based on data collected from one or more LiDAR sensors, radar sensors, stereo cameras, standard cameras, acoustic sensors, or any combinations thereof. In some examples, the model update request component 645 is capable of, configured to, or operable to support a means for outputting a request to a UE to collect one or more targeted scans of the one or more selected regions.

In some examples, to support updating the initial 3D model, the digital twin component 640 is capable of, configured to, or operable to support a means for performing a coarse alignment between a first selected region and a first higher fidelity 3D model associated with the first selected region. In some examples, to support updating the initial 3D model, the digital twin component 640 is capable of, configured to, or operable to support a means for performing a fine alignment between portions of the first selected region and corresponding portions of the first higher fidelity 3D model. In some examples, the coarse alignment matches one or more anchor points between the first selected region and the first higher fidelity 3D model, and aligns a bounding box associated with the selected region with a corresponding bounding box of the first higher fidelity 3D model. In some examples, the fine alignment is based on an iterative algorithm to reduce residual error between overlapping mesh portions of the first selected region and the first higher fidelity 3D model.

In some examples, the data from the initial 3D model is replaced in the one or more selected regions by associated data of one or more corresponding higher fidelity 3D models. In some examples, data from the initial 3D model is combined with associated data of one or more corresponding higher fidelity 3D models in the one or more selected regions. In some examples, the data of the one or more corresponding higher fidelity 3D models is weighted when combined with the data from the initial 3D model, and where a magnitude of the weighting is based on a reliability of an associated source of the one or more higher fidelity 3D models. In some examples, the initial 3D model is a representation of one or more objects in spatial dimensions using 3D units that include one or more of point cloud units, 3D mesh units, or voxel units.

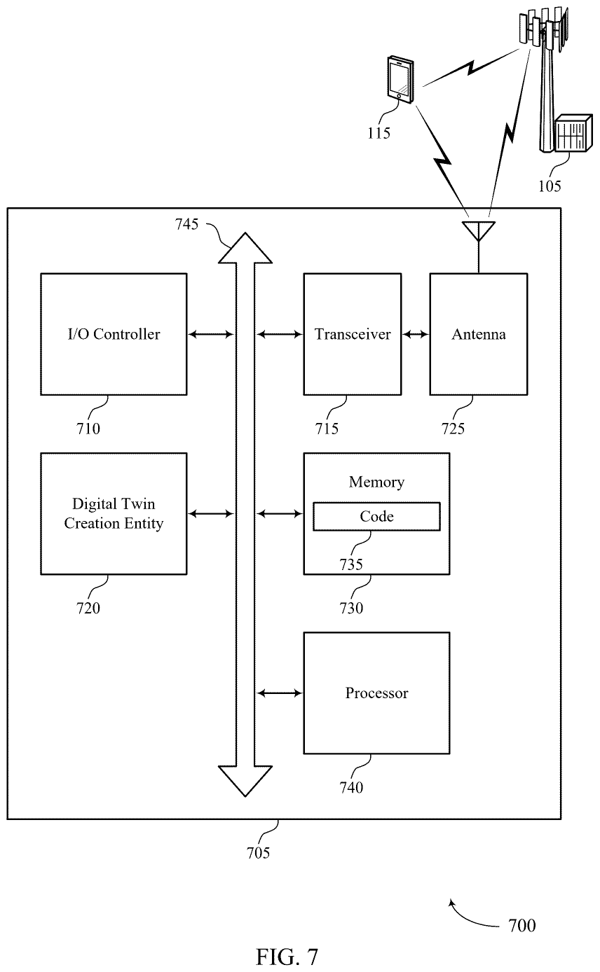

FIG. 7 shows a diagram of a system 700 including a device 705 that supports RF model adaptation techniques in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a digital twin creation entity 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting RF model adaptation techniques). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The digital twin creation entity 720 may support RF model adaptation in accordance with examples as disclosed herein. For example, the digital twin creation entity 720 is capable of, configured to, or operable to support a means for obtaining an initial 3D model of a locality associated with the RF model, the initial 3D model associated with a set of multiple regions that each have associated RF properties. The digital twin creation entity 720 is capable of, configured to, or operable to support a means for selecting one or more regions of the initial 3D model to be updated with enhanced physical characteristics relative to corresponding physical characteristics in the initial 3D model, the one or more regions selected based on an associated impact to the RF model. The digital twin creation entity 720 is capable of, configured to, or operable to support a means for obtaining one or more higher fidelity 3D models of each of the one or more regions to be updated, the one or more higher fidelity 3D models providing the enhanced physical characteristics for a corresponding region of the one or more regions to be updated. The digital twin creation entity 720 is capable of, configured to, or operable to support a means for updating the initial 3D model with the one or more higher fidelity 3D models to provide an adapted 3D model of the locality associated with the RF model.

By including or configuring the digital twin creation entity 720 in accordance with examples as described herein, the device 705 may support techniques for refining a digital twin such that the digital twin is an accurate representation of a real-world version of a geographic area.

In some examples, the digital twin creation entity 720 may be configured to perform various operations (e.g., receiving, monitoring, transmitting) using or otherwise in cooperation with the transceiver 715, the one or more antennas 725, or any combination thereof. Although the digital twin creation entity 720 is illustrated as a separate component, in some examples, one or more functions described with reference to the digital twin creation entity 720 may be supported by or performed by the at least one processor 740, the at least one memory 730, the code 735, or any combination thereof. For example, the code 735 may include instructions executable by the at least one processor 740 to cause the device 705 to perform various aspects of RF model adaptation techniques as described herein, or the at least one processor 740 and the at least one memory 730 may be otherwise configured to, individually or collectively, perform or support such operations.

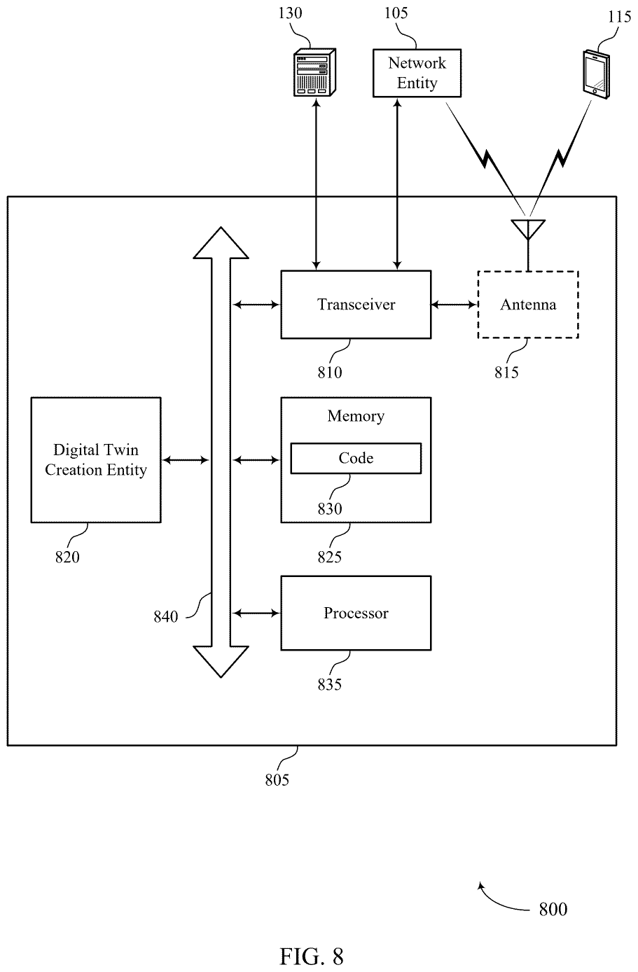

FIG. 8 shows a diagram of a system 800 including a device 805 that supports RF model adaptation techniques in accordance with one or more aspects of the present disclosure. The device 805 may be an example of or include components of a device 405, a device 505, or a network entity 105 as described herein. The device 805 may communicate with other network devices or network equipment such as one or more of the network entities 105, UEs 115, or any combination thereof. The communications may include communications over one or more wired interfaces, over one or more wireless interfaces, or any combination thereof. The device 805 may include components that support outputting and obtaining communications, such as a digital twin creation entity 820, a transceiver 810, one or more antennas 815, at least one memory 825, code 830, and at least one processor 835. These components may be in electronic communication or otherwise coupled (e.g., operatively, communicatively, functionally, electronically, electrically) via one or more buses (e.g., a bus 840).

The transceiver 810 may support bi-directional communications via wired links, wireless links, or both as described herein. In some examples, the transceiver 810 may include a wired transceiver and may communicate bi-directionally with another wired transceiver. Additionally, or alternatively, in some examples, the transceiver 810 may include a wireless transceiver and may communicate bi-directionally with another wireless transceiver. In some examples, the device 805 may include one or more antennas 815, which may be capable of transmitting or receiving wireless transmissions (e.g., concurrently). The transceiver 810 may also include a modem to modulate signals, to provide the modulated signals for transmission (e.g., by one or more antennas 815, by a wired transmitter), to receive modulated signals (e.g., from one or more antennas 815, from a wired receiver), and to demodulate signals. In some implementations, the transceiver 810 may include one or more interfaces, such as one or more interfaces coupled with the one or more antennas 815 that are configured to support various receiving or obtaining operations, or one or more interfaces coupled with the one or more antennas 815 that are configured to support various transmitting or outputting operations, or a combination thereof. In some implementations, the transceiver 810 may include or be configured for coupling with one or more processors or one or more memory components that are operable to perform or support operations based on received or obtained information or signals, or to generate information or other signals for transmission or other outputting, or any combination thereof. In some implementations, the transceiver 810, or the transceiver 810 and the one or more antennas 815, or the transceiver 810 and the one or more antennas 815 and one or more processors or one or more memory components (e.g., the at least one processor 835, the at least one memory 825, or both), may be included in a chip or chip assembly that is installed in the device 805. In some examples, the transceiver 810 may be operable to support communications via one or more communications links (e.g., communication link(s) 125, backhaul communication link(s) 120, a midhaul communication link 162, a fronthaul communication link 168).

The at least one memory 825 may include RAM, ROM, or any combination thereof. The at least one memory 825 may store computer-readable, computer-executable, or processor-executable code, such as the code 830. The code 830 may include instructions that, when executed by one or more of the at least one processor 835, cause the device 805 to perform various functions described herein. The code 830 may be stored in a non-transitory computer-readable medium such as system memory or another type of memory. In some cases, the code 830 may not be directly executable by a processor of the at least one processor 835 but may cause a computer (e.g., when compiled and executed) to perform functions described herein. In some cases, the at least one memory 825 may include, among other things, a BIOS which may control basic hardware or software operation such as the interaction with peripheral components or devices. In some examples, the at least one processor 835 may include multiple processors and the at least one memory 825 may include multiple memories. One or more of the multiple processors may be coupled with one or more of the multiple memories which may, individually or collectively, be configured to perform various functions herein (for example, as part of a processing system).

The at least one processor 835 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 835 may be configured to operate a memory array using a memory controller. In some other cases, a memory controller may be integrated into one or more of the at least one processor 835. The at least one processor 835 may be configured to execute computer-readable instructions stored in a memory (e.g., one or more of the at least one memory 825) to cause the device 805 to perform various functions (e.g., functions or tasks supporting RF model adaptation techniques). For example, the device 805 or a component of the device 805 may include at least one processor 835 and at least one memory 825 coupled with one or more of the at least one processor 835, the at least one processor 835 and the at least one memory 825 configured to perform various functions described herein. The at least one processor 835 may be an example of a cloud-computing platform (e.g., one or more physical nodes and supporting software such as operating systems, virtual machines, or container instances) that may host the functions (e.g., by executing code 830) to perform the functions of the device 805. The at least one processor 835 may be any one or more suitable processors capable of executing scripts or instructions of one or more software programs stored in the device 805 (such as within one or more of the at least one memory 825).

In some examples, the at least one processor 835 may include multiple processors and the at least one memory 825 may include multiple memories. One or more of the multiple processors may be coupled with one or more of the multiple memories, which may, individually or collectively, be configured to perform various functions herein. In some examples, the at least one processor 835 may be a component of a processing system, which may refer to a system (such as a series) of machines, circuitry (including, for example, one or both of processor circuitry (which may include the at least one processor 835) and memory circuitry (which may include the at least one memory 825)), or components, that receives or obtains inputs and processes the inputs to produce, generate, or obtain a set of outputs. The processing system may be configured to perform one or more of the functions described herein. For example, the at least one processor 835 or a processing system including the at least one processor 835 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 825 or otherwise, to perform one or more of the functions described herein.

In some examples, a bus 840 may support communications of (e.g., within) a protocol layer of a protocol stack. In some examples, a bus 840 may support communications associated with a logical channel of a protocol stack (e.g., between protocol layers of a protocol stack), which may include communications performed within a component of the device 805, or between different components of the device 805 that may be co-located or located in different locations (e.g., where the device 805 may refer to a system in which one or more of the digital twin creation entity 820, the transceiver 810, the at least one memory 825, the code 830, and the at least one processor 835 may be located in one of the different components or divided between different components).

In some examples, the digital twin creation entity 820 may manage aspects of communications with a core network 130 (e.g., via one or more wired or wireless backhaul links). For example, the digital twin creation entity 820 may manage the transfer of data communications for client devices, such as one or more UEs 115. In some examples, the digital twin creation entity 820 may manage communications with one or more other network entities 105, and may include a controller or scheduler for controlling communications with UEs 115 (e.g., in cooperation with the one or more other network devices). In some examples, the digital twin creation entity 820 may support an X2 interface within an LTE/LTE-A wireless communications network technology to provide communication between network entities 105.

The digital twin creation entity 820 may support RF model adaptation in accordance with examples as disclosed herein. For example, the digital twin creation entity 820 is capable of, configured to, or operable to support a means for obtaining an initial 3D model of a locality associated with the RF model, the initial 3D model associated with a set of multiple regions that each have associated RF properties. The digital twin creation entity 820 is capable of, configured to, or operable to support a means for selecting one or more regions of the initial 3D model to be updated with enhanced physical characteristics relative to corresponding physical characteristics in the initial 3D model, the one or more regions selected based on an associated impact to the RF model. The digital twin creation entity 820 is capable of, configured to, or operable to support a means for obtaining one or more higher fidelity 3D models of each of the one or more regions to be updated, the one or more higher fidelity 3D models providing the enhanced physical characteristics for a corresponding region of the one or more regions to be updated. The digital twin creation entity 820 is capable of, configured to, or operable to support a means for updating the initial 3D model with the one or more higher fidelity 3D models to provide an adapted 3D model of the locality associated with the RF model.

By including or configuring the digital twin creation entity 820 in accordance with examples as described herein, the device 805 may support techniques for refining a digital twin such that the digital twin is an accurate representation of a real-world version of a geographic area

In some examples, the digital twin creation entity 820 may be configured to perform various operations (e.g., receiving, obtaining, monitoring, outputting, transmitting) using or otherwise in cooperation with the transceiver 810, the one or more antennas 815 (e.g., where applicable), or any combination thereof. Although the digital twin creation entity 820 is illustrated as a separate component, in some examples, one or more functions described with reference to the digital twin creation entity 820 may be supported by or performed by the transceiver 810, one or more of the at least one processor 835, one or more of the at least one memory 825, the code 830, or any combination thereof (for example, by a processing system including at least a portion of the at least one processor 835, the at least one memory 825, the code 830, or any combination thereof). For example, the code 830 may include instructions executable by one or more of the at least one processor 835 to cause the device 805 to perform various aspects of RF model adaptation techniques as described herein, or the at least one processor 835 and the at least one memory 825 may be otherwise configured to, individually or collectively, perform or support such operations.

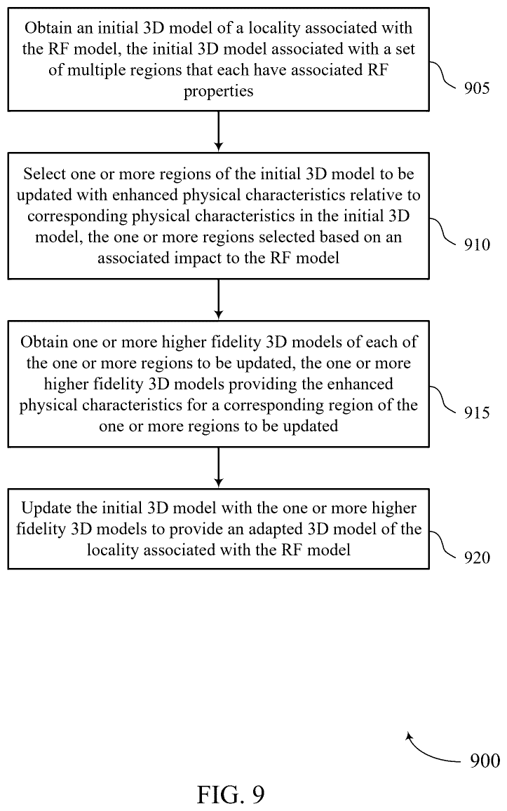

FIG. 9 shows a flowchart illustrating a method 900 that supports RF model adaptation techniques in accordance with one or more aspects of the present disclosure. The operations of the method 900 may be implemented by a digital twin server, a UE, or a network entity or its components as described herein. For example, the operations of the method 900 may be performed by a digital twin server, a UE or a network entity as described with reference to FIGS. 1 through 8. In some examples, a digital twin server, a UE, or a network entity may execute a set of instructions to control the functional elements of the digital twin server, the UE, or the network entity to perform the described functions. Additionally, or alternatively, the digital twin server, the UE, or the network entity may perform aspects of the described functions using special-purpose hardware.

At 905, the method may include obtaining an initial 3D model of a locality associated with the RF model, the initial 3D model associated with a set of multiple regions that each have associated RF properties. The operations of 905 may be performed in accordance with examples as disclosed herein. In some examples, aspects of the operations of 905 may be performed by an input image data component 625 as described with reference to FIG. 6.

At 910, the method may include selecting one or more regions of the initial 3D model to be updated with enhanced physical characteristics relative to corresponding physical characteristics in the initial 3D model, the one or more regions selected based on an associated impact to the RF model. The operations of 910 may be performed in accordance with examples as disclosed herein. In some examples, aspects of the operations of 910 may be performed by a region selection component 630 as described with reference to FIG. 6.

At 915, the method may include obtaining one or more higher fidelity 3D models of each of the one or more regions to be updated, the one or more higher fidelity 3D models providing the enhanced physical characteristics for a corresponding region of the one or more regions to be updated. The operations of 915 may be performed in accordance with examples as disclosed herein. In some examples, aspects of the operations of 915 may be performed by a region update component 635 as described with reference to FIG. 6.

At 920, the method may include updating the initial 3D model with the one or more higher fidelity 3D models to provide an adapted 3D model of the locality associated with the RF model. The operations of 920 may be performed in accordance with examples as disclosed herein. In some examples, aspects of the operations of 920 may be performed by a digital twin component 640 as described with reference to FIG. 6.

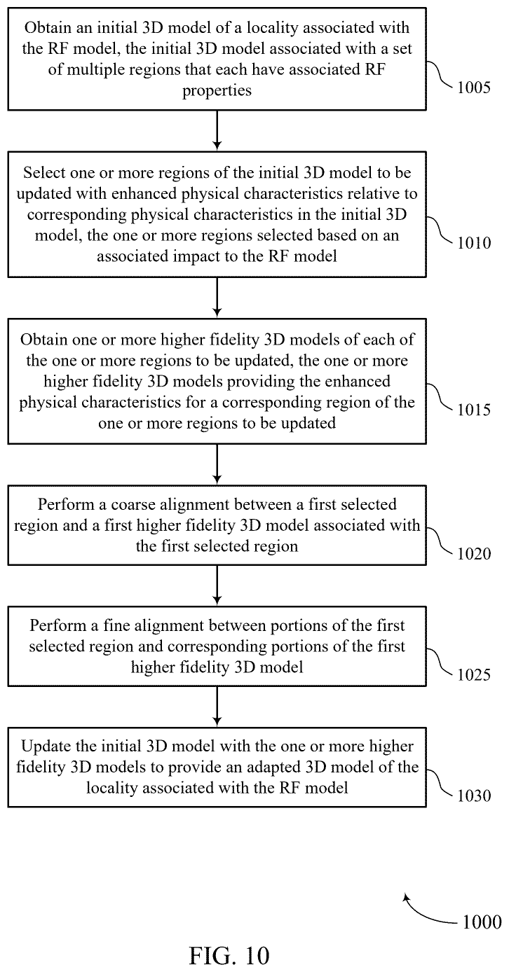

FIG. 10 shows a flowchart illustrating a method 1000 that supports RF model adaptation techniques in accordance with one or more aspects of the present disclosure. The operations of the method 1000 may be implemented by a digital twin server, a UE, or a network entity or its components as described herein. For example, the operations of the method 1000 may be performed by a digital twin server, a UE, or a network entity as described with reference to FIGS. 1 through 8. In some examples, a digital twin server, a UE, or a network entity may execute a set of instructions to control the functional elements of the digital twin server, the UE, or the network entity to perform the described functions. Additionally, or alternatively, the digital twin server, the UE, or the network entity may perform aspects of the described functions using special-purpose hardware.

At 1005, the method may include obtaining an initial 3D model of a locality associated with the RF model, the initial 3D model associated with a set of multiple regions that each have associated RF properties. The operations of 1005 may be performed in accordance with examples as disclosed herein. In some examples, aspects of the operations of 1005 may be performed by an input image data component 625 as described with reference to FIG. 6.

At 1010, the method may include selecting one or more regions of the initial 3D model to be updated with enhanced physical characteristics relative to corresponding physical characteristics in the initial 3D model, the one or more regions selected based on an associated impact to the RF model. The operations of 1010 may be performed in accordance with examples as disclosed herein. In some examples, aspects of the operations of 1010 may be performed by a region selection component 630 as described with reference to FIG. 6.

At 1015, the method may include obtaining one or more higher fidelity 3D models of each of the one or more regions to be updated, the one or more higher fidelity 3D models providing the enhanced physical characteristics for a corresponding region of the one or more regions to be updated. The operations of 1015 may be performed in accordance with examples as disclosed herein. In some examples, aspects of the operations of 1015 may be performed by a region update component 635 as described with reference to FIG. 6.

At 1020, the method may include performing a coarse alignment between a first selected region and a first higher fidelity 3D model associated with the first selected region. The operations of 1020 may be performed in accordance with examples as disclosed herein. In some examples, aspects of the operations of 1020 may be performed by a digital twin component 640 as described with reference to FIG. 6.

At 1025, the method may include performing a fine alignment between portions of the first selected region and corresponding portions of the first higher fidelity 3D model. The operations of 1025 may be performed in accordance with examples as disclosed herein. In some examples, aspects of the operations of 1025 may be performed by a digital twin component 640 as described with reference to FIG. 6.

At 1030, the method may include updating the initial 3D model with the one or more higher fidelity 3D models to provide an adapted 3D model of the locality associated with the RF model. The operations of 1030 may be performed in accordance with examples as disclosed herein. In some examples, aspects of the operations of 1030 may be performed by a digital twin component 640 as described with reference to FIG. 6.

The following provides an overview of aspects of the present disclosure:

Aspect 1: A method for RF model adaptation, comprising: obtaining an initial 3D model of a locality associated with the RF model, the initial 3D model associated with a plurality of regions that each have associated RF properties; selecting one or more regions of the initial 3D model to be updated with enhanced physical characteristics relative to corresponding physical characteristics in the initial 3D model, the one or more regions selected based at least in part on an associated impact to the RF model; obtaining one or more higher fidelity 3D models of each of the one or more regions to be updated, the one or more higher fidelity 3D models providing the enhanced physical characteristics for a corresponding region of the one or more regions to be updated; and updating the initial 3D model with the one or more higher fidelity 3D models to provide an adapted 3D model of the locality associated with the RF model.

Aspect 2: The method of aspect 1, wherein the selecting the one or more regions of the initial 3D model comprises identifying one or more of: one or more occluded or obstructed regions of the initial 3D model, one or more regions associated with a higher density of RF devices relative to other regions, one or more coverage boundaries associated with one or more RF network nodes, or one or more RF metrics associated with the one or more regions.

Aspect 3: The method of any of aspects 1 through 2, wherein the selecting the one or more regions of the initial 3D model comprises identifying a first region based at least in part on one or more of: an associated confidence of RF attributes of the first region that is below a threshold confidence value, one or more anomalies of an RF model output associated with the first region, one or more discrepancies of an expected physical property of the first region, or an unexpected physical property of the first region relative to a corresponding physical property of an adjacent a second region.

Aspect 4: The method of any of aspects 1 through 3, wherein the initial 3D model is based at least in part on a first order survey associated with the locality, and the one or more higher fidelity 3D models are based at least in part on data associated with the selected regions collected by additional sensors or reconstruction techniques.

Aspect 5: The method of aspect 4, wherein the one or more higher fidelity 3D models are based at least in part on data collected from one or more LiDAR sensors, radar sensors, stereo cameras, standard cameras, acoustic sensors, or any combinations thereof.

Aspect 6: The method of any of aspects 1 through 5, further comprising: outputting a request to a UE to collect one or more targeted scans of the one or more selected regions.

Aspect 7: The method of any of aspects 1 through 6, wherein updating the initial 3D model comprises: performing a coarse alignment between a first selected region and a first higher fidelity 3D model associated with the first selected region; and performing a fine alignment between portions of the first selected region and corresponding portions of the first higher fidelity 3D model.

Aspect 8: The method of aspect 7, wherein the coarse alignment matches one or more anchor points between the first selected region and the first higher fidelity 3D model, and aligns a bounding box associated with the selected region with a corresponding bounding box of the first higher fidelity 3D model.

Aspect 9: The method of any of aspects 7 through 8, wherein the fine alignment is based at least in part on an iterative algorithm to reduce residual error between overlapping mesh portions of the first selected region and the first higher fidelity 3D model.

Aspect 10: The method of any of aspects 1 through 9, wherein the data from the initial 3D model is replaced in the one or more selected regions by associated data of one or more corresponding higher fidelity 3D models.

Aspect 11: The method of any of aspects 1 through 10, wherein data from the initial 3D model is combined with associated data of one or more corresponding higher fidelity 3D models in the one or more selected regions.

Aspect 12: The method of aspect 11, wherein the data of the one or more corresponding higher fidelity 3D models is weighted when combined with the data from the initial 3D model, and wherein a magnitude of the weighting is based at least in part on a reliability of an associated source of the one or more higher fidelity 3D models.

Aspect 13: The method of any of aspects 1 through 12, wherein the initial 3D model is a representation of one or more objects in spatial dimensions using 3D units that include one or more of point cloud units, 3D mesh units, or voxel units.

Aspect 14: An apparatus for RF model adaptation, comprising one or more memories storing processor-executable code, and one or more processors coupled with the one or more memories and individually or collectively operable to execute the code to cause the apparatus to perform a method of any of aspects 1 through 13.

Aspect 15: An apparatus for RF model adaptation, comprising at least one means for performing a method of any of aspects 1 through 13.

Aspect 16: A non-transitory computer-readable medium storing code for RF model adaptation, the code comprising instructions executable by one or more processors to perform a method of any of aspects 1 through 13.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
one or more memories storing processor-executable code; and
one or more processors coupled with the one or more memories and individually or collectively operable to execute the code to cause the apparatus to:
obtain an initial three-dimensional (3D) model of a locality associated with a radio frequency (RF) model, the initial 3D model associated with a plurality of regions that each have associated RF properties;
select one or more regions of the initial 3D model to be updated with enhanced physical characteristics relative to corresponding physical characteristics in the initial 3D model, the one or more regions selected based at least in part on an associated impact to the RF model;
obtain one or more higher fidelity 3D models of each of the one or more regions to be updated, the one or more higher fidelity 3D models providing the enhanced physical characteristics for a corresponding region of the one or more regions to be updated; and
update the initial 3D model with the one or more higher fidelity 3D models to provide an adapted 3D model of the locality associated with the RF model.

2. The apparatus of claim 1, wherein the one or more processors are individually or collectively operable to execute the code to cause the apparatus to select the one or more regions of the initial 3D model based on identifying one or more of:
one or more occluded or obstruct regions of the initial 3D model,
one or more regions associated with a higher density of RF devices relative to other regions,
one or more coverage boundaries associated with one or more RF network nodes, or
one or more RF metrics associated with the one or more regions.

3. The apparatus of claim 1, wherein the one or more processors are individually or collectively operable to execute the code to cause the apparatus to select a first region of the initial 3D model based on identifying one or more of:
an associated confidence of RF attributes of the first region that be below a threshold confidence value,
one or more anomalies of an RF model output associated with the first region,
one or more discrepancies of an expect physical property of the first region, or
an unexpected physical property of the first region relative to a corresponding physical property of an adjacent a second region.

4. The apparatus of claim 1, wherein the initial 3D model is based at least in part on a first order survey associated with the locality, and the one or more higher fidelity 3D models are based at least in part on data associated with the selected regions collected by additional sensors or reconstruction techniques.

5. The apparatus of claim 4, wherein the one or more higher fidelity 3D models are based at least in part on data collected from one or more LiDAR sensors, radar sensors, stereo cameras, standard cameras, acoustic sensors, or any combinations thereof.

6. The apparatus of claim 1, wherein the one or more processors are individually or collectively further operable to execute the code to cause the apparatus to:
output a request to a user equipment (UE) to collect one or more targeted scans of the one or more selected regions.

7. The apparatus of claim 1, wherein, to update the initial 3D model, the one or more processors are individually or collectively operable to execute the code to cause the apparatus to:
perform a coarse alignment between a first selected region and a first higher fidelity 3D model associated with the first selected region; and
perform a fine alignment between portions of the first selected region and corresponding portions of the first higher fidelity 3D model.

8. The apparatus of claim 7, wherein the coarse alignment matches one or more anchor points between the first selected region and the first higher fidelity 3D model, and aligns a bounding box associated with the selected region with a corresponding bounding box of the first higher fidelity 3D model.

9. The apparatus of claim 7, wherein the fine alignment is based at least in part on an iterative algorithm to reduce residual error between overlapping mesh portions of the first selected region and the first higher fidelity 3D model.

10. The apparatus of claim 1, wherein data from the initial 3D model is replaced in the one or more selected regions by associated data of one or more corresponding higher fidelity 3D models.

11. The apparatus of claim 1, wherein data from the initial 3D model is combined with associated data of one or more corresponding higher fidelity 3D models in the one or more selected regions.

12. The apparatus of claim 11, wherein the data of the one or more corresponding higher fidelity 3D models is weighted when combined with the data from the initial 3D model, and wherein a magnitude of the weighting is based at least in part on a reliability of an associated source of the one or more higher fidelity 3D models.

13. The apparatus of claim 1, wherein:
the initial 3D model is a representation of one or more objects in spatial dimensions using 3D units that include one or more of point cloud units, 3D mesh units, or voxel units.

14. A method for radio frequency (RF) model adaptation, comprising:
obtaining an initial three-dimensional (3D) model of a locality associated with the RF model, the initial 3D model associated with a plurality of regions that each have associated RF properties;
selecting one or more regions of the initial 3D model to be updated with enhanced physical characteristics relative to corresponding physical characteristics in the initial 3D model, the one or more regions selected based at least in part on an associated impact to the RF model;
obtaining one or more higher fidelity 3D models of each of the one or more regions to be updated, the one or more higher fidelity 3D models providing the enhanced physical characteristics for a corresponding region of the one or more regions to be updated; and
updating the initial 3D model with the one or more higher fidelity 3D models to provide an adapted 3D model of the locality associated with the RF model.

15. The method of claim 14, wherein the selecting the one or more regions of the initial 3D model comprises identifying one or more of:
one or more occluded or obstructed regions of the initial 3D model,
one or more regions associated with a higher density of RF devices relative to other regions,
one or more coverage boundaries associated with one or more RF network nodes, or
one or more RF metrics associated with the one or more regions.

16. The method of claim 14, wherein the selecting the one or more regions of the initial 3D model comprises identifying a first region based at least in part on one or more of:
an associated confidence of RF attributes of the first region that is below a threshold confidence value,
one or more anomalies of an RF model output associated with the first region,
one or more discrepancies of an expected physical property of the first region, or
an unexpected physical property of the first region relative to a corresponding physical property of an adjacent a second region.

17. The method of claim 14, wherein the initial 3D model is based at least in part on a first order survey associated with the locality, and the one or more higher fidelity 3D models are based at least in part on data associated with the selected regions collected by additional sensors or reconstruction techniques.

18. The method of claim 14, wherein updating the initial 3D model comprises:
performing a coarse alignment between a first selected region and a first higher fidelity 3D model associated with the first selected region; and
performing a fine alignment between portions of the first selected region and corresponding portions of the first higher fidelity 3D model.

19. A non-transitory computer-readable medium storing code for radio frequency (RF) model adaptation, the code comprising instructions executable by one or more processors to:
obtain an initial three-dimensional (3D) model of a locality associated with the RF model, the initial 3D model associated with a plurality of regions that each have associated RF properties;
select one or more regions of the initial 3D model to be updated with enhanced physical characteristics relative to corresponding physical characteristics in the initial 3D model, the one or more regions selected based at least in part on an associated impact to the RF model;
obtain one or more higher fidelity 3D models of each of the one or more regions to be updated, the one or more higher fidelity 3D models providing the enhanced physical characteristics for a corresponding region of the one or more regions to be updated; and
update the initial 3D model with the one or more higher fidelity 3D models to provide an adapted 3D model of the locality associated with the RF model.

20. The non-transitory computer-readable medium of claim 19, wherein the instructions to are executable by the one or more processors to:
one or more occluded or obstruct regions of the initial 3D model,
one or more regions associated with a higher density of RF devices relative to other regions,
one or more coverage boundaries associated with one or more RF network nodes, or
one or more RF metrics associated with the one or more regions.
